(19) United States
(12) Patent Application Publication
(10) Pub. No.: US 2024/0347861 A1
(43) Pub. Date: Oct. 17, 2024

(54) SECONDARY BATTERY AND ELECTRICAL DEVICE

(71) Applicant: Ningde Amperex Technology Limited, Ningde (CN)

(72) Inventors: Qiao ZENG, Ningde (CN); Tianjing ZHANG, Ningde (CN)

(73) Assignee: Ningde Amperex Technology Limited, Ningde (CN)

(21) Appl. No.: 18/619,929

(22) Filed: Mar. 28, 2024

(30) Foreign Application Priority Data
Apr. 13, 2023 (CN) 202310389687.1

(51) Int. Cl. H01M 50/46; H01M 50/119; H01M 50/417; H01M 50/42; H01M 50/426; H01M 50/449; H01M 50/466

(52) U.S. Cl. CPC H01M 50/46; H01M 50/119; H01M 50/417; H01M 50/42; H01M 50/426; H01M 50/449; H01M 50/466

(57) ABSTRACT

A secondary battery includes an electrode assembly and a pocket. The electrode assembly includes a plurality of electrode plates and a separator including a first separator layer and a second separator layer. The plurality of electrode plates include a first outermost electrode plate, a second outermost electrode plate, a first second-to-outermost electrode plate, and a second second-to-outermost electrode plate. The first outermost electrode plate and the second outermost electrode plate are located on two opposite sides of the plurality of electrode plates in the first direction. The first outermost electrode plate and the first second-to-outermost electrode plate are located on two opposite sides of the first separator layer. The second outermost electrode plate and the second second-to-outermost electrode plate are located on two opposite sides of the second separator layer. The pocket includes a first sidewall extending in the first direction.

### CROSS-REFERENCE TO RELATED APPLICATION

This application claims the priority to the Chinese Patent Application No. 202310389687.1, filed on Apr. 13, 2023, the content of which is incorporated by reference in its entirety.

### TECHNICAL FIELD

This application relates to the technical field of pouch-type batteries, and in particular, to a secondary battery and an electrical device containing the secondary battery.

### BACKGROUND

A lithium-ion battery is widely applied in electric vehicles and consumer electronics products by virtue of advantages such as a high energy density, a high output power, a long cycle life, and little environmental pollution. However, when subjected to abnormal conditions such as extrusion, collision, or puncture, the lithium-ion battery is prone to catch fire or explode, thereby causing severe hazards. Therefore, the safety challenges of the lithium-ion battery have greatly bottlenecked the application and popularization of the lithium-ion battery. A large number of experimental results show that an internal short circuit of the battery is a root cause of the safety hazards of the lithium-ion battery. Therefore, it is urgent to reduce the risk of an internal short circuit in a battery.

### SUMMARY

An objective of this application is to disclose a secondary battery to reduce the risk of an internal short circuit in the secondary battery.

A first aspect of this application provides a secondary battery, including an electrode assembly and a pocket. The electrode assembly includes a plurality of electrode plates and a separator. In a first direction, the plurality of electrode plates are stacked, and the separator is disposed between two adjacent electrode plates among the plurality of electrode plates. The plurality of electrode plates include a first outermost electrode plate and a second outermost electrode plate located on two opposite sides in the first direction. The plurality of electrode plates further include a first second-to-outermost electrode plate adjacent to the first outermost electrode plate and of an opposite polarity and a second second-to-outermost electrode plate adjacent to the second outermost electrode plate and of an opposite polarity. The separator includes a first separator layer located between the first outermost electrode plate and the first second-to-outermost electrode plate. The separator further includes a second separator layer located between the second outermost electrode plate and the second second-to-outermost electrode plate. The pocket accommodates the electrode assembly. The pocket includes a first sidewall extending in the first direction. In a second direction perpendicular to the first direction, the first separator layer includes a first extension portion that extends beyond the first outermost electrode plate and the first second-to-outermost electrode plate, and the second separator layer includes a second extension portion that extends beyond the second outermost electrode plate and the second second-to-outermost electrode plate. The first extension portion and the second extension portion are bonded together to form a first composite portion. In the second direction, the first composite portion is located between the plurality of electrode plates and the first sidewall.

In the secondary battery according to an embodiment of this application, the first extension portion of the first separator layer and the second extension portion of the second separator layer are bonded together to form a first composite portion, where the first separator layer and the second separator layer are located on the outermost layers in the first direction among the plurality of separator layers. The bonded first separator layer and second separator layer clamp a part of the electrode assembly, the part being located between the first separator layer and the second separator layer, thereby reducing the risk of contact and short-circuiting between adjacent electrode plates caused by shrinkage of each separator layer. In addition, the first composite portion is located between the plurality of electrode plates and the first sidewall, thereby reducing the overall thickness of the secondary battery and increasing energy density. In addition, the end portion of the separator extends beyond the electrode plate, and the extension part is positioned between the electrode assembly and the sidewall of the pocket, thereby reducing an extrusion stress on the electrode plate when the lateral edges of the electrode assembly are squeezed. In addition, an additional amount of electrolyte solution can be stored, thereby increasing the service life.

According to some embodiments of this application, the pocket further includes a second sidewall extending in the first direction. The second sidewall and first sidewall are disposed opposite to each other in the second direction. The first separator layer and the second separator layer are configured to be separate separators. In the second direction, the first separator layer further includes a third extension portion extending beyond the first outermost electrode plate and the first second-to-outermost electrode plate, and the third extension portion is disposed opposite to the first extension portion in the second direction. The second separator layer further includes a fourth extension portion extending beyond the second outermost electrode plate and the second second-to-outermost electrode plate, and the fourth extension portion is disposed opposite to the second extension portion in the second direction. The third extension portion and the fourth extension portion are bonded together to form a second composite portion. In the second direction, the second composite portion is located between the plurality of electrode plates and the second sidewall.

According to some embodiments of this application, the first separator layer and the second separator layer are configured to be a one-piece separator. The separator is a Z-shaped folded structure. The one-piece separator includes just two end portions. In this way, just the two end portions need to be fixed, thereby reducing the risk of short circuits and reducing the manufacturing cost.

According to some embodiments of this application, the pocket includes a first packaging portion. A first cavity is provided in the first packaging portion. The electrode assembly is at least partially accommodated in the first cavity. The first cavity includes a first wall extending along the first direction. A projection of the first composite portion projected onto the first wall in the second direction is located inside the first wall. This reduces the risk of folding the first composite portion to the position of the plurality of electrode plates to increase the overall thickness of the secondary battery in a process of vacuumizing the pocket.

According to some embodiments of this application, the first composite portion is a folded structure, thereby reducing the space occupied by the first composite portion in the second direction, and increasing the energy density.

According to some embodiments of this application, a length of the first composite portion or the second composite portion along the first direction is greater than or equal to 1 mm and less than or equal to a thickness of the electrode assembly along the first direction. In this way, the extension portions that form the composite portion are bonded firmly together, thereby reducing the risk that the composite portion is sealed into the sealing portion of the pocket.

According to some embodiments of this application, the first outermost electrode plate is a single-side-coated electrode plate, and the first second-to-outermost electrode plate is a double-side-coated electrode plate, thereby fully utilizing the active material of the electrode plate and increasing the energy density.

According to some embodiments of this application, the pocket is an aluminum laminated film. The first outermost electrode plate is a positive electrode plate. The first second-to-outermost electrode plate is a negative electrode plate. In the second direction, the first second-to-outermost electrode plate extends beyond the first outermost electrode plate. In this way, all the lithium ions deintercalated from the positive electrode plate can be received by and intercalated into a corresponding negative active material, thereby ensuring high safety and efficiency of the secondary battery. The aluminum laminated film is highly capable of being punched to form a cavity and is of high strength. When the pocket is an aluminum laminated film, the first outermost electrode plate and the second outermost electrode plate are the positive electrode plate, so as to reduce the risk of the electrochemical corrosion of an aluminum layer in the aluminum laminated film.

According to some embodiments of this application, the separator includes a substrate layer. The substrate layer includes at least one of polyethylene or polypropylene, so that the extension portion of the separator can be hot-pressed to form a composite portion.

According to some embodiments of this application, the separator further includes a first layer disposed on the substrate layer. The first layer includes a first binder. The first binder includes at least one of polyvinylidene difluoride or polyacrylate ester. The separator is bonded and fixed to at least one adjacent electrode plate by the first layer, thereby further reducing the risk of shrinkage of the separator.

According to some embodiments of this application, the first extension portion and the second extension portion are hot-pressed to form the first composite portion. Hot pressing is performed by taking advantage of the polyolefin nature of the separator, thereby making the separator bondable, simplifying the process, and reducing the cost, without exerting an additional stress on the lateral edge of the electrode assembly.

According to some embodiments of this application, the first composite portion includes an indentation. The indentation includes a patterned protrusion structure. The indentation with a patterned protrusion structure enhances the reliability of the bonding of the first extension portion and the second extension portion, and cushions the pressure on the lateral edge of the electrode assembly.

According to some embodiments of this application, the secondary battery further includes a second binder. The first extension portion and the second extension portion are bonded together by the second binder. The second binder includes at least one of polyacrylate ester, epoxy resin, rubber, hot-melt adhesive, or organosilicone. This makes the bonding more reliable between the first extension portion and the second extension portion.

According to some embodiments of this application, no winding adhesive tape configured to bond and fix the first outermost electrode plate and the second outermost electrode plate is disposed in the secondary battery. The winding adhesive tape gives rise to nonuniform thickness, inferior interface, and decrease in energy density, and the omission of the winding adhesive tape alleviates such problems.

According to some embodiments of this application, the pocket includes a first packaging portion and a second packaging portion. The first packaging portion contains a cavity accommodating at least a part of the electrode assembly. The first packaging portion and the second packaging portion are connected together to form a sealing portion to accommodate a body portion of the electrode assembly and seal the body portion. The body portion includes a first surface and a second surface extending along the second direction. The first surface and the second surface are disposed opposite to each other in the first direction. The first surface is located in the first packaging portion. The second surface is located in the second packaging portion. A start end of the first composite portion is closer to the first surface than the second surface. In this way, the start end of the first composite portion is disposed close to the first surface, thereby reducing the risk of folding the first composite portion in a process of vacuumizing the pocket.

A second aspect of this application provides an electrical device. The electrical device includes the secondary battery according to any one of the foregoing embodiments.

### BRIEF DESCRIPTION OF DRAWINGS

FIG. 1 is a cross-sectional schematic view of a secondary battery according to an embodiment of this application;

FIG. 2 is a schematic diagram of a pocket of a secondary battery before sealing according to an embodiment of this application;

FIG. 3 is a cross-sectional schematic view of a separator of a secondary battery according to an embodiment of this application;

FIG. 4 is a cross-sectional schematic view of a secondary battery according to an embodiment of this application;

FIG. 5 is a schematic plan view of a composite portion of the separator shown in FIG. 4;

FIG. 6 is a cross-sectional schematic view of a secondary battery according to another embodiment of this application;

FIG. 7 is a cross-sectional schematic view of a secondary battery according to still another embodiment of this application;

FIG. 8 is a cross-sectional schematic view of a secondary battery according to still another embodiment of this application;

FIG. 9 is a cross-sectional schematic view of a secondary battery according to still another embodiment of this application;

FIG. 10 is a cross-sectional schematic view of a secondary battery according to a comparative embodiment of this application;

FIG. 11 is a cross-sectional schematic view of a secondary battery according to another comparative embodiment of this application; and

FIG. 12 is a cross-sectional schematic view of a secondary battery according to still another comparative embodiment of this application.

### LIST OF REFERENCE NUMERALS

secondary battery 100;
electrode assembly 10;
pocket 20;
electrode plate 11;
separator 12;
first outermost electrode plate 111;
second outermost electrode plate 112;
first second-to-outermost electrode plate 113;
second second-to-outermost electrode plate 114;
first metal layer 111a;
first active layer 111b;
second metal layer 113a;
second active layer 113b;
first separator layer 121;
second separator layer 122;
first extension portion 121a;
second extension portion 122a;
first composite portion 12a;
third extension portion 121b;
fourth extension portion 122b;
second composite portion 12b;
body portion 21;
sealing portion 22;
first sidewall 211;
second sidewall 212;
first surface 213;
second surface 214;
first packaging portion 20a;
second packaging portion 20b;
first region 20a1;
second region 20a2;
third region 20b1;
fourth region 20b2;
first cavity S1;
first wall S11;
second wall S12;
first part 12a1;
second part 12a2;
third part 12b1;
fourth part 12b2;
substrate layer 125;
indentation P;
first layer 126;
fifth extension portion 121c;
sixth extension portion 122c;
first third-to-outermost electrode plate 115;
second third-to-outermost electrode plate 116;
third separator layer 123;
fourth separator layer 124;
seventh extension portion 123b;
eighth extension portion 124a;
second binder 30;
winding adhesive tape 50;
first direction Z;
second direction X;
third direction Y.

This application is further described below with reference to the following specific embodiments and the foregoing drawings.

### DETAILED DESCRIPTION

The following describes the technical solutions in the embodiments of this application clearly and thoroughly. Evidently, the described embodiments are merely a part of but not all of the embodiments of this application. Unless otherwise defined, all technical and scientific terms used herein bear the same meanings as what is normally understood by a person skilled in the technical field of this application. The terms used in the specification of this application are merely intended to describe specific embodiments but not to limit this application.

The following describes the embodiments of this application in detail. However, this application may be embodied in many different forms, and is in no way construed as being limited to the illustrative embodiments described herein. Rather, the illustrative embodiments are provided in order to impart this application thoroughly in detail to those skilled in the art.

In addition, for brevity and clarity, the size or thickness of various components and layers in the drawings may be scaled up. Throughout the text, the same reference numerical means the same element. As used herein, the term “and/or” includes any and all combinations of one or more related items preceding and following the term. In addition, understandably, when an element A is referred to as “connecting” an element B, the element A may be directly connected to the element B, or an intermediate element C may exist through which the element A and the element B can be connected to each other indirectly.

Further, the term “may” used in describing an embodiment of this application indicates “one or more embodiments of this application”.

The technical terms used herein is intended to describe specific embodiments but not intended to limit this application. Unless otherwise expressly specified in the context, a noun used herein in the singular form includes the plural form thereof. Further, understandably, the terms “include”, “comprise”, and “contain” used herein mean existence of the feature, numerical value, step, operation, element and/or component under discussion, but do not preclude the existence or addition of one or more other features, numerical values, steps, operations, elements, components, and/or any combinations thereof.

Space-related terms, such as “on”, may be used herein for ease of describing the relationship between one element or feature and other element (elements) or feature (features) as illustrated in the drawings. Understandably, the space-related terms are intended to include different directions of a device or apparatus in use or operation in addition to the directions illustrated in the drawings. For example, if a device in the drawing is turned over, an element described as “above” or “on” another element or feature will be oriented “under” or “below” the other element or feature. Therefore, the illustrative term “on” includes both an up direction and a down direction. Understandably, although the terms such as first, second, third may be used herein to describe various elements, components, regions, layers and/or parts, such elements, components, regions, layers and/or parts are not limited by the terms. Such terms are intended to distinguish one element, component, region, layer or part from another element, component, region, layer, or part. Therefore, a first element, a first component, a first region, a first layer, or a first part mentioned below may be referred to as a second element, a second component, a second region, a second layer, or a second part, without departing from the teachings of the illustrative embodiments.

In the prior art, an end portion of a separator of a stacked-type electrode assembly is prone to shrink in a drop test or a hot-oven test, resulting in contact and short-circuiting between adjacent positive and negative electrode plates located at the outermost layer and the second-to-outermost layer respectively. Furthermore, if the outermost electrode plate is a positive electrode plate, the second-to-outermost negative electrode plate protrudes beyond the outermost positive electrode plate. The protruding part may make the negative active layer peel off during mechanical abuse, thereby being prone to cause a short circuit.

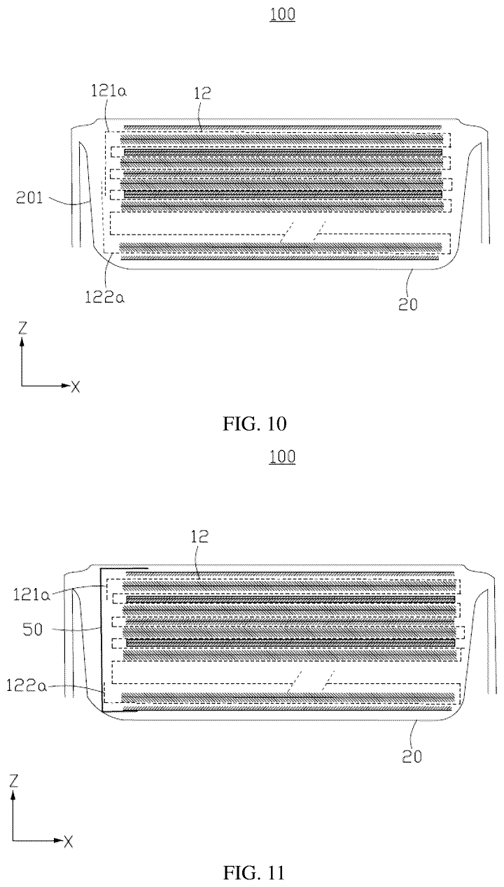

One possible technical solution to the above problem is: As shown in FIG. 10, extending the two end portions of the separator 12 separately to form a first extension portion 121a and a second extension portion 122a, and disposing the first extension portion 121a and the second extension portion 122a between the stacked-type electrode assembly 10 and the sidewall 201 of the pocket 20. However, when the secondary battery 100 is vacuumized to remove surplus electrolyte solution and generated gas in the pocket 20, the first extension portion 121a and the second extension portion 122a may be folded to reach the space between the electrode assembly 10 and the second surface 214 of the pocket 20. Due to uncontrollability of the folding, the folding not only increases the thickness of the secondary battery 100 and reduces the energy density, but also leads to an uneven surface of the secondary battery 100. In this case, as shown in FIG. 11, winding adhesive tape 50 is disposed. The winding adhesive tape 50 is bonded to three adjacent lateral faces of the electrode assembly 10, and bonded to the first extension portion 121a and the second extension portion 122a. However, the bonding increases the thickness of the secondary battery 100, reduces the energy density, increases the cost, and impairs the infiltration effect of the electrolyte solution.

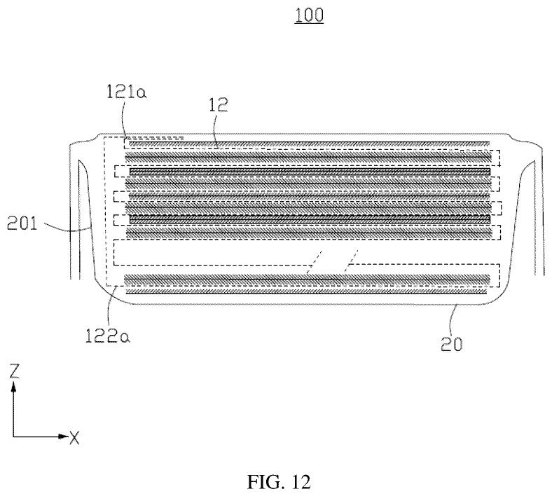

Another possible technical solution to the above problem is: As shown in FIG. 12, extending the two end portions of the separator 12 separately to form a first extension portion 121a and a second extension portion 122a, and folding the first extension portion 121a and the second extension portion 122a until the extension portions reach the space between the electrode assembly 10 and the second surface 214 of the pocket 20. However, the folding the first extension portion 121a and the second extension portion 122a until reaching the space between the electrode assembly 10 and the second surface 214 of the pocket 20 increases the thickness of the secondary battery 100 significantly.

To solve the above problem, the applicant hereof extends the end portion of the separator to form a first extension portion and a second extension portion, fixes the first extension portion and the second extension portion to form a first composite portion, and disposes the first composite portion between the electrode assembly and a sidewall of the pocket to reduce the risk of a short circuit without compromising the energy density. The following describes some embodiments of this application in more detail.

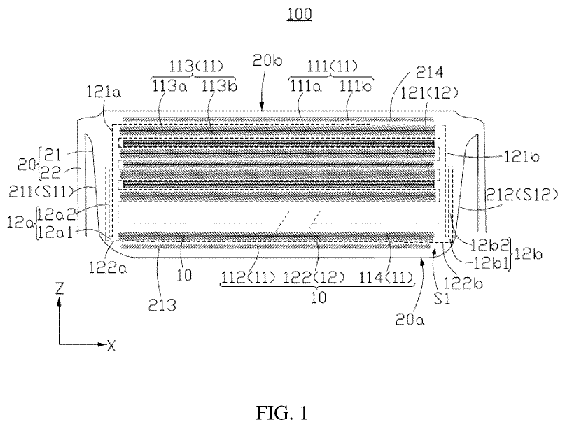

Referring to FIG. 1, an embodiment of this application provides a secondary battery 100, including an electrode assembly 10 and a pocket 20. The electrode assembly 10 is accommodated in the pocket 20. The electrode assembly 10 includes a plurality of electrode plates 11 and separators 12. The plurality of electrode plates 11 are stacked along a first direction Z. Each separator 12 is disposed between two adjacent electrode plates 11.

The plurality of electrode plates 11 include a first outermost electrode plate 111 and a second outermost electrode plate 112 located on two opposite sides in the first direction Z. The plurality of electrode plates 11 further include a first second-to-outermost electrode plate 113 adjacent to the first outermost electrode plate 111 and of an opposite polarity and a second second-to-outermost electrode plate 114 adjacent to the second outermost electrode plate 112 and of an opposite polarity. The first outermost electrode plate 111 and the second outermost electrode plate 112 are positive electrode plates, and the first second-to-outermost electrode plate 113 and the second second-to-outermost electrode plate 114 are negative electrode plates. The outermost electrode plates, located at the opposite sides in the first direction Z, among the plurality of electrode plates 11, are positive electrode plates, so that the negative active materials on the adjacent second-to-outermost negative electrode plates can be fully utilized, thereby improving the energy density of the secondary battery 100. In the second direction X perpendicular to the first direction Z, the first second-to-outermost electrode plate 113 extends beyond the first outermost electrode plate 111. The second second-to-outermost electrode plate 114 extends beyond the second outermost electrode plate 112. In this way, all the lithium ions deintercalated from the first outermost electrode plate 111 and the second outermost electrode plate 112 that serve as the positive electrodes can be received by and intercalated into the corresponding negative active materials, thereby improving safety and efficiency of the secondary battery 100. In some other embodiments, the outermost electrode plates, located at the opposite sides in the first direction Z, among the plurality of electrode plates 11, are negative electrode plates; or, in the outermost electrode plates, located at the opposite sides in the first direction Z, among the plurality of electrode plates 11, one is a positive electrode plate, and the other is a negative electrode plate.

Both the first outermost electrode plate 111 and the second outermost electrode plate 112 are single-side-coated electrode plates. In this application, a single-side-coated electrode plate means an electrode plate coated with an active material on only one surface. Understandably, a surface, uncoated with the active material, of the single-side-coated electrode plate, may be coated with another functional layer such as an insulation layer. In some embodiments, both the first outermost electrode plate 111 and the second outermost electrode plate 112 each include a first metal layer 111a and a first active layer 111b disposed on one surface of the first metal layer 111a. The first active layer 111b of the first outermost electrode plate 111 is oriented toward the first second-to-outermost electrode plate 113. The first active layer 111b of the second outermost electrode plate 112 is oriented toward the second second-to-outermost electrode plate 114. The first metal layer 111a may be a current collector capable of collecting current, and may include at least one of Ni, Ti, Cu, Ag, Au, Pt, Fe, Al, or a combination thereof. The first active layer 111b includes a positive active material. The positive active material may include at least one of lithium cobalt oxide, lithium manganese oxide, lithium nickel oxide, lithium nickel cobalt manganese oxide, lithium iron phosphate, lithium manganese iron phosphate, lithium vanadium phosphate, lithium vanadyl phosphate, a lithium-rich manganese-based material, a lithium nickel cobalt aluminum oxide, or a combination thereof. The positive electrode plate located on the outermost layer is a single-side-coated electrode plate, thereby fully utilizing the positive active material of the positive electrode plate and increasing the energy density. In some other embodiments, the first outermost electrode plate 111 and the second outermost electrode plate 112 may be double-side-coated electrode plates, and each include a first metal layer 111a and a first active layer 111b disposed on two surfaces of the first metal layer 111a, the two surfaces being opposite to each other in the first direction Z. Alternatively, in the first outermost electrode plate 111 and the second outermost electrode plate 112, one may be a single-side-coated electrode plate, and the other may be a double-side-coated electrode plate.

Both the first second-to-outermost electrode plate 113 and the second second-to-outermost electrode plate 114 are double-side-coated electrode plates. In this application, a double-side-coated electrode plate means an electrode plate coated with an active material on both of the two opposite surfaces. In some other embodiments, the first second-to-outermost electrode plate 113 and the second second-to-outermost electrode plate 114 each include a second metal layer 113a and a second active layer 113b disposed on two surfaces of the second metal layer 113a, the two surfaces being opposite to each other in the first direction Z. The second metal layer 113a serves a function of collecting current, and may include at least one of Ni, Ti, Cu, Ag, Au, Pt, Fe, Al, or a combination thereof. The second active layer 113b includes a negative active material. The negative active material may be at least one selected from a graphite material, an alloy material, lithium metal, or an alloy thereof. The graphite material may be at least one selected from artificial graphite or natural graphite. The alloy material may be at least one selected from silicon, silicon oxide, tin, or titanium sulfide.

The separator 12 includes a plurality of separator layers distributed in the first direction Z. Each separator layer is located between two adjacent electrode plates 11, and is configured to prevent direct contact between the two adjacent electrode plates 11. The plurality of separator layers are configured to be independent separators. The plurality of separator layers include a first separator layer 121 located between the first outermost electrode plate 111 and the first second-to-outermost electrode plate 113, and a second separator layer 122 located between the second outermost electrode plate 112 and the second second-to-outermost electrode plate 114. In the second direction X, the first separator layer 121 includes a first extension portion 121a that extends beyond the first outermost electrode plate 111 and the first second-to-outermost electrode plate 113, and the second separator layer 122 includes a second extension portion 122a that extends beyond the second outermost electrode plate 112 and the second second-to-outermost electrode plate 114. The first extension portion 121a and the second extension portion 122a are located on the same side of the electrode assembly 10 in the second direction X. The first extension portion 121a and the second extension portion 122a are bonded together to form a first composite portion 12a. Understandably, in the accompanying drawings of the embodiments of this application, the circumstance of no contact between the first extension portion 121a and the second extension portion 122a is merely intended to clearly illustrate the first extension portion 121a and the second extension portion 122a. The first separator layer 121 and the second separator layer 122 extend beyond the electrode plate 11 in the second direction X and are bonded together, so that the first separator layer 121 and the second separator layer 122 are less prone to shrink or fold over, thereby reducing the risk that the two adjacent electrode plates 11 of opposite polarities are directly opposite to each other. In addition, the first separator layer 121 and second separator layer 122 clamped together clamp a part of the electrode assembly 10 in between, thereby reducing the risk of shrinking or folding the separator layer between the first separator layer 121 and the second separator layer 122, and in turn, reducing the risk that the two adjacent electrode plates 11 of opposite polarities are directly opposite to each other, and reducing the risk of contact and short-circuiting between the two adjacent electrode plates 11 of opposite polarities (the positive electrode plate and the negative electrode plate). In addition, the first separator layer 121 and the second separator layer 122 extend beyond the adjacent positive electrode plate and negative electrode plate. The protruding part of the negative electrode plate extending beyond the positive electrode plate is always covered by the corresponding separator layer, thereby reducing the risk of peeling off the active layer on the protruding part of the negative electrode plate, and reducing the risk of an internal short circuit of the secondary battery 100.

In the second direction X, the first separator layer 121 further includes a third extension portion 121b that extends beyond the first outermost electrode plate 111 and the first second-to-outermost electrode plate 113, and the third extension portion is disposed opposite to the first extension portion 121a. The second separator layer 122 includes a fourth extension portion 122b that extends beyond the second outermost electrode plate 112 and the second second-to-outermost electrode plate 114, and the fourth extension portion is disposed opposite to the second extension portion 122a. The third extension portion 121b and the fourth extension portion 122b are bonded together to form a second composite portion 12b, thereby further reducing the risk of contact and short-circuiting between the two adjacent electrode plates 11 caused by shrinkage or folding of the separator 12.

The material of the pocket 20 is a heat-sealable material such as an aluminum laminated film or steel laminated film. In some embodiments, the pocket 20 is an aluminum laminated film. The aluminum laminated film is highly capable of being punched to form a cavity and is of high strength. In manufacturing a pocket 20 from an aluminum laminated film, the outermost electrode plates located on the opposite sides in the first direction Z among the plurality of electrode plates 11 are positive electrode plates, so as to reduce the risk of the electrochemical corrosion of an aluminum layer in the aluminum laminated film. The pocket 20 includes a body portion 21 and a sealing portion 22. The electrode assembly 10 is disposed in the body portion 21. The body portion 21 includes a first sidewall 211 and a second sidewall 212 extending in the first direction Z as well as a first surface 213 and a second surface 214 extending in the second direction X. The first sidewall 211 and the second sidewall 212 are disposed opposite to each other in the second direction X. The first surface 213 and the second surface 214 are disposed opposite to each other in the first direction Z. The sealing portion 22 is connected to the first sidewall 211, and is configured to seal the body portion 21 and reduce the risk of leakage. In the second direction X, the first composite portion 12a is located between the first sidewall 211 and the plurality of electrode plates 11, and the second composite portion 12b is located between the second sidewall 212 and the plurality of electrode plates 11. In this way, neither the first composite portion 12a nor the second composite portion 12b overlaps the plurality of electrode plates 11 in the first direction Z, thereby reducing the dimensions of the secondary battery 100 in the first direction Z, and increasing the energy density. In addition, this arrangement reduces an extrusion stress on the electrode plate 11 when the lateral edges of the electrode assembly 10 are squeezed. Moreover, an additional amount of electrolyte solution can be stored, thereby increasing the service life.

In some embodiments, in the first direction Z, the width of the first composite portion 12a and/or the second composite portion 12b is greater than or equal to 1 mm and less than or equal to the thickness of the electrode assembly 10. When the width of the first composite portion 12a and/or the second composite portion 12b is less than 1 mm, the extension portions of a plurality of separator layers may be weakly bonded. In this way, the plurality of separator layers may be folded to reach the space between the plurality of electrode plates 11 and the first surface 213 (the second surface 214) in a vacuumizing process, thereby reducing the energy density and resulting in unevenness of the surface of the secondary battery 100. When the width of the first composite portion 12a and/or the second composite portion 12b is greater than the thickness of the electrode assembly 10, the first composite portion 12a and/or the second composite portion 12b is oversized. This may cause the first composite portion 12a and/or the second composite portion 12b to be sealed into the sealing portion 22 during sealing, thereby impairing the sealing effect.

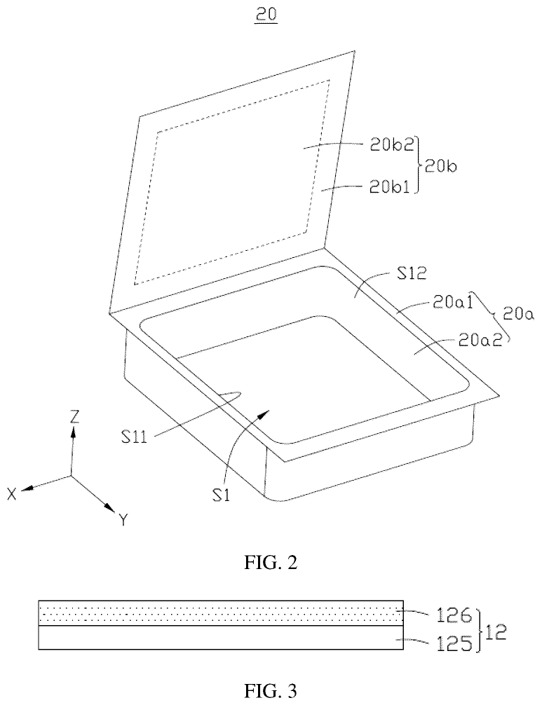

Referring to FIG. 2 together, the pocket 20 includes a first packaging portion 20a and a second packaging portion 20b disposed opposite to each other in the first direction Z, and the pocket 20 is formed by sealing the first packaging portion 20a and the second packaging portion 20b. The first packaging portion 20a includes a first region 20al and a second region 20a2 connected to each other. The three lateral edges of the second region 20a2 are surrounded by the first region 20a1. The second packaging portion 20b includes a third region 20b1 and a fourth region 20b2 connected to each other. The three lateral edges of the fourth region 20b2 are surrounded by the third region 20b1. The fourth region 20b2 of the second packaging portion 20b is substantially in the shape of a flat plate. A first cavity S1 is created in the second region 20a2 of the first packaging portion 20a, and is configured to accommodate the electrode assembly 10. The first cavity S1 and the fourth region 20b2 jointly form a body portion 21 accommodate the electrode assembly 10. The first region 20al is connected to the third region 20b1 to form a sealing portion 22.

The first cavity S1 includes a first wall S11 and a second wall S12 extending along the first direction Z. The first wall S11 is at least a part of the first sidewall 211. The second wall S12 is at least a part of the second sidewall 212. The first surface 213 is located in the first packaging portion 20a. The second surface 214 is located in the second packaging portion 20b. In the first direction Z, when the dimension of the electrode assembly 10 is less than the depth of the first cavity S1, after the pocket 20 is formed by sealing, the fourth region 20b2 located in the body portion 21 is flat plate-shaped and seals the opening of the first cavity S1. At which time, the electrode assembly 10 can be completely accommodated in the first cavity S1. The first wall S11 is used as the first sidewall 211. The second wall S12 is used as the second sidewall 212. When the dimension of the electrode assembly 10 is equal to or greater than the depth of the first cavity S1, the fourth region 20b2 located in the body portion 21 forms a second cavity (not shown in the drawing) after the pocket 20 is formed by sealing, or the fourth region 20b2 forms a second cavity before the pocket 20 is formed by sealing. The first cavity S1 and the second cavity jointly form a body portion 21. The second cavity includes a third sidewall (not shown in the drawing) and a fourth sidewall (not shown in the drawing) extending along the first direction Z. The first wall S11 and the third sidewall jointly form the first sidewall 211. The second wall S12 and the fourth sidewall jointly form the second sidewall 212. The second extension portion 122a is closer to the first surface 213 than the first extension portion 121a. The first extension portion 121a extends toward the first surface 213 until the second extension portion 122a from a side close to the second surface 214, and is then bonded to the second extension portion 122a to form a first composite portion 12a. In this way, the start end of the first composite portion 12a is close to the first surface 213, thereby reducing the risk of folding the first composite portion 12a. Similarly, the fourth extension portion 122b is closer to the first surface 213 than the third extension portion 121b. The third extension portion 121b extends toward the first surface 213 until the fourth extension portion 122b from a side close to the second surface 214, and is then bonded to the fourth extension portion 122b to form a first composite portion 12a. In this way, the start end of the second composite portion 12b is close to the first surface 213. In this application, the start end of the first composite portion 12a means a start position of bonding between the first extension portion 121a and the second extension portion 122a. The start end of the second composite portion 12b means a start position of bonding between the third extension portion 121b and the fourth extension portion 122b. A projection of the first composite portion 12a projected onto the first wall S11 in the second direction X is located inside the first wall S11. A projection of the second composite portion 12b projected onto the second wall S12 in the second direction X is located inside the second wall S12, thereby further reducing the risk that the first composite portion 12a and the second composite portion 12b are folded to reach the space between the plurality of electrode plates 11 and the second surface 214, reducing the dimension of the secondary battery 100 in the first direction Z, and increasing the energy density.

Referring to FIG. 1, the first composite portion 12a and the second composite portion 12b are a folded structure. The first composite portion 12a and the second composite portion 12b are bent toward the second surface 214 from a side close to the first surface 213 to form a folded structure. The first composite portion 12a is disposed opposite to the first sidewall 211 in the second direction X, and the second composite portion 12b is disposed opposite to the second sidewall 212 in the second direction X, thereby reducing the dimension of the secondary battery 100 in the second direction X and improving space utilization and energy density. The first composite portion 12a and the second composite portion 12b may be a single-edge-folded, double-edge-folded, or multi-edge-folded structure formed by folding once, twice, or more times. The structure is not limited herein. In this embodiment, the first composite portion 12a includes a first part 12al and a second part 12a2 connected to each other. The second composite portion 12b includes a third part 12b1 and a fourth part 12b2 connected to each other. The first part 12al and the third part 12b1 extend away from the plurality of electrode plates 11 along the second direction X. The second part 12a2 and the fourth part 12b2 extend toward the second packaging portion 20b along the first direction Z.

The separator 12 is a single-layer or multi-layer sheet. As shown in FIG. 3, the separator 12 includes a substrate layer 125. The substrate layer 125 includes at least one of polyethylene or polypropylene. The substrate layer 125 of the first extension portion 121a and the substrate layer 125 of the second extension portion 122a are hot-pressed to form a first composite portion 12a. The substrate layer 125 of the third extension portion 121b and the substrate layer 125 of the fourth extension portion 122b are hot-pressed to form a second composite portion 12b. During the hot pressing, the substrate layer 125 is melted and bonded, so as to bond the first extension portion 121a and the second extension portion 122a together to form the first composite portion 12a, and to bond the third extension portion 121b and the fourth extension portion 122b together to form the second composite portion 12b. In preparing the electrode assembly 10, the electrode assembly 10 may be hot-pressed to achieve tighter bonding between the electrode plate 11 and the separator 12. In hot-pressing the electrode assembly 10, the first extension portion 121a and the second extension portion 122a may be hot-pressed simultaneously, without requiring an additional hot-pressing process, thereby simplifying the preparation process.

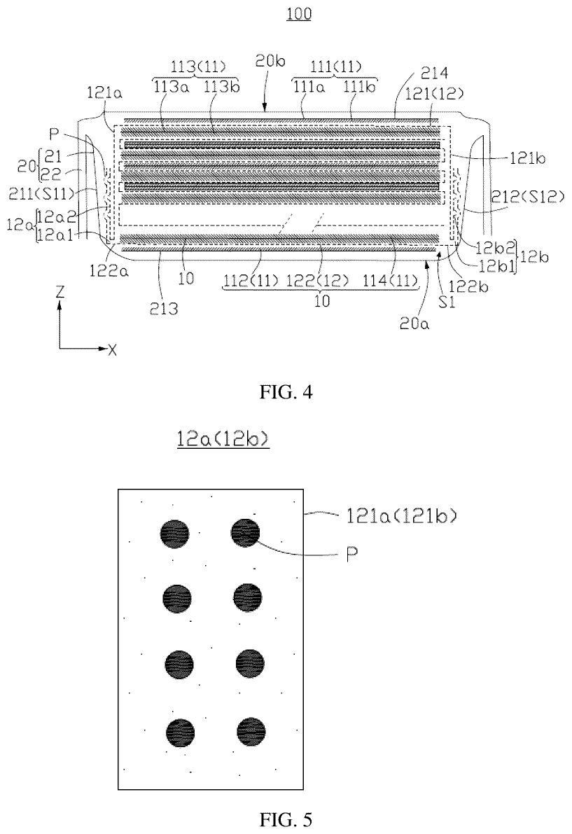

Referring to FIG. 4 to FIG. 5, by means of hot-pressing, an indentation P is created on the surfaces of the first composite portion 12a and the second composite portion 12b. Understandably, by adjusting the pressure applied in the hot-pressing, the indentation P may be caused to appear on just one of the first extension portion 121a or the second extension portion 122a of the first composite portion 12a (or on just one of the third extension portion 121b or the fourth extension portion 122b of the second composite portion 12b), or appear on both the first extension portion 121a and the second extension portion 122a of the first composite portion 12a (or on both the third extension portion 121b and the fourth extension portion 122b of the second composite portion 12b) simultaneously. The indentation P includes a patterned protrusion structure. The protrusion structure may be in the form of dots, strips, or other shapes. FIG. 5 shows a circumstance in which the protrusion structure is in the form of dots.

Referring to FIG. 3 together, in some other embodiments, the separator 12 further includes a first layer 126 disposed on the surface of the substrate layer 125. The first layer 126 may be disposed on one surface or two opposite surfaces of the substrate layer 125, without being limited herein. The first layer 126 includes a first binder. The first binder includes at least one of polyvinylidene difluoride or polyacrylate ester. Each separator layer may be bonded and fixed to at least one adjacent electrode plate 11 by the first layer 126, thereby further reducing the risk of shrinkage of the separator 12. In addition, the extension portion of the separator 12 may be bonded and fixed by the first layer 126 to form a first composite portion 12a and a second composite portion 12b, so as to make the bonding of the extension portion of the separator 12 more reliable.

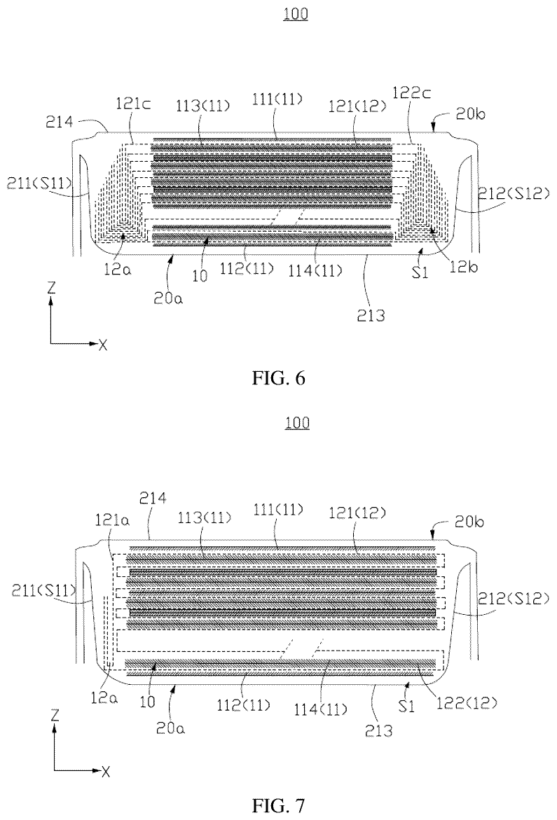

Referring to FIG. 6, in some embodiments, in the second direction X, each separator layer of the separator 12 includes a fifth extension portion 121c and a sixth extension portion 122c extending beyond a plurality of electrode plates 11 and disposed opposite to each other. The plurality of fifth extension portions 121c of the plurality of separator layers are bonded together to form a first composite portion 12a, and the plurality of sixth extension portions 122c of the plurality of separator layers are bonded together to form a second composite portion 12b, thereby further reducing the risk that the shrinkage of any separator layer causes adjacent electrode plates 11 to be directly opposite to each other.

Referring to FIG. 7, in some embodiments, the plurality of separator layers of the separator 12 are configured to be a one-piece separator. That is, the first separator layer 121 and the second separator layer 122 are configured to be a one-piece separator. Specifically, the plurality of separator layers are obtained by folding one piece of separator. The separator 12 is a Z-shaped folded structure. In other words, the one-piece separator 12 is Z-bent in the first direction Z to form a Z-shaped folded structure. The one-piece separator 12 includes just two end portions. In this way, just the two end portions need to be fixed, thereby reducing the risk of short circuits and reducing the manufacturing cost. Specifically, the first separator layer 121 includes no third extension portion, and the second separator layer 122 includes no fourth extension portion. Only the first extension portion 121a of the first separator layer 121 and the second extension portion 122a of the second separator layer 122 are bonded together and fixed to form a first composite portion 12a.

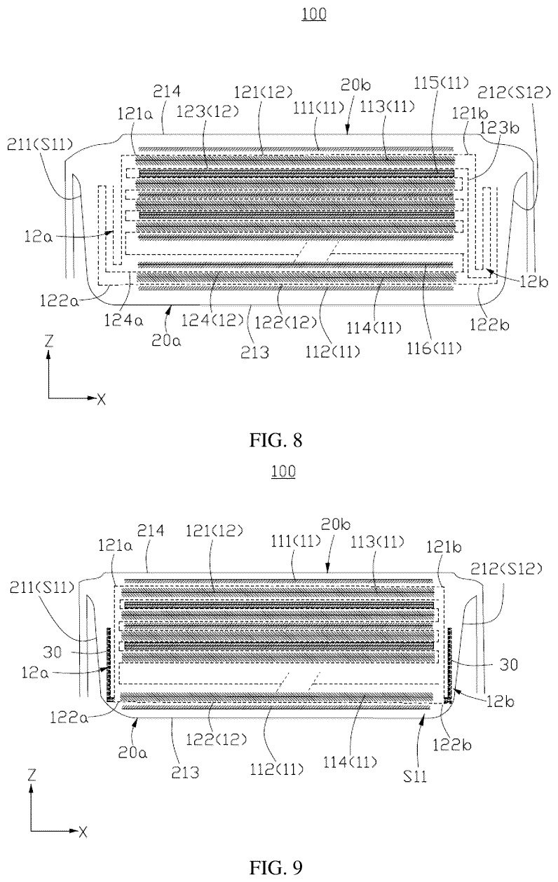

Referring to FIG. 8, in some embodiments, the plurality of electrode plates 11 further include a first third-to-outermost electrode plate 115 adjacent to the first second-to-outermost electrode plate 113 and of an opposite polarity and a second third-to-outermost electrode plate 116 adjacent to the second second-to-outermost electrode plate 114 and of an opposite polarity. In the first direction Z, the first outermost electrode plate 111 and the first third-to-outermost electrode plate 115 are located on two opposite sides of the first second-to-outermost electrode plate 113, and the second outermost electrode plate 112 and the second third-to-outermost electrode plate 116 are located on two opposite sides of the second second-to-outermost electrode plate 114. The separator 12 further includes a third separator layer 123 located between the first second-to-outermost electrode plate 113 and the first third-to-outermost electrode plate 115, and a fourth separator layer 124 located between the second second-to-outermost electrode plate 114 and the second third-to-outermost electrode plate 116. The first separator layer 121, the second separator layer 122, the third separator layer 123, and the fourth separator layer 124 are configured to be a one-piece separator. In the second direction X, the third separator layer 123 includes a seventh extension portion 123b that extends beyond the first second-to-outermost electrode plate 113 and the first third-to-outermost electrode plate 115, and the fourth separator layer 124 includes an eighth extension portion 124a that extends beyond the second second-to-outermost electrode plate 114 and the second third-to-outermost electrode plate 116. The seventh extension portion 123b and the eighth extension portion 124a are located on different sides of a plurality of electrode plates 11 in the second direction X. The first extension portion 121a, the second extension portion 122a, and the eighth extension portion 124a are bonded together to form a first composite portion 12a. The third extension portion 121b, the fourth extension portion 122b, and the seventh extension portion 123b are bonded together to form a second composite portion 12b.

Referring to FIG. 9, in some embodiments, the secondary battery 100 further includes a second binder 30. The first extension portion 121a and the second extension portion 122a are bonded by the second binder 30 to form the first composite portion 12a. The third extension portion 121b and the fourth extension portion 122b are bonded by the second binder 30 to form the second composite portion 12b, thereby improving reliability of the bonding between the extension portions. The second binder 30 may be disposed, but is not limited to being disposed, between the first extension portion 121a and the second extension portion 122a, or between the third extension portion 121b and the fourth extension portion 122b. The second binder 30 includes at least one of polyacrylate ester, epoxy resin, rubber, hot-melt adhesive, or organosilicone.

In the secondary battery 100 according to this application, the extension portions of the first separator layer 121 and the second separator layer 122 located on the outermost layers in the first direction Z among a plurality of separator layers are bonded together to form a composite portion, and a part of the electrode assembly 10 located between the first separator layer 121 and the second separator layer 122 is clamped, thereby reducing the risk of contact and short-circuiting between adjacent electrode plates 11 caused by shrinkage of each separator layer. In this way, the first outermost electrode plate 111 and the second outermost electrode plate 112 located on the outermost layers in the first direction Z among the plurality of electrode plates 11 do not need to be bonded by adhesive tape for the purpose of clamping the electrode assembly 10 in the first direction Z. In other words, no winding adhesive tape for bonding and fixing the first outermost electrode plate 111 and the second outermost electrode plate 112 is disposed in the secondary battery 100, thereby increasing the energy density, and improving the infiltration effect of the electrolyte solution. Moreover, the first composite portion 12a is located between the plurality of electrode plates 11 and the first sidewall 211, thereby reducing the overall thickness of the secondary battery 100 and increasing the energy density.

Another embodiment of this application further provides an electrical device. The electrical device includes any one of the secondary batteries disclosed above. The electrical device according to this application may be, but is not limited to, a laptop computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, lighting appliance, toy, game console, watch, electric tool, flashlight, camera, large household battery, lithium-ion capacitor, and the like.

What is disclosed above is merely exemplary embodiments of this application, and in no way constitutes a limitation on the protection scope of this application. Therefore, any equivalent variations made based on the claims of this application still fall within the scope covered by this application.

What is claimed is:

1. A secondary battery comprising:
an electrode assembly, comprising a plurality of electrode plates and a separator; in a first direction, the plurality of electrode plates are stacked, and the separator is disposed between two adjacent electrode plates among the plurality of electrode plates; the plurality of electrode plates comprise a first outermost electrode plate and a second outermost electrode plate located on two opposite sides in the first direction; the plurality of electrode plates further comprise a first second-to-outermost electrode plate adjacent to the first outermost electrode plate and of an opposite polarity than the first outermost electrode plate, and a second second-to-outermost electrode plate adjacent to the second outermost electrode plate and of an opposite polarity than the second outermost electrode plate; and the separator comprises a first separator layer located between the first outermost electrode plate and the first second-to-outermost electrode plate, and the separator further comprises a second separator layer located between the second outermost electrode plate and the second second-to-outermost electrode plate; and
a pocket, accommodating the electrode assembly, wherein the pocket comprises a first sidewall extending in the first direction; wherein
in a second direction perpendicular to the first direction, the first separator layer comprises a first extension portion extending beyond the first outermost electrode plate and the first second-to-outermost electrode plate, and the second separator layer comprises a second extension portion extending beyond the second outermost electrode plate and the second second-to-outermost electrode plate; the first extension portion and the second extension portion are bonded together to form a first composite portion; and in the second direction, the first composite portion is located between the plurality of electrode plates and the first sidewall.

2. The secondary battery according to claim 1, wherein the pocket further comprises a second sidewall extending in the first direction, and the second sidewall and first sidewall are disposed opposite to each other in the second direction; the first separator layer and the second separator layer are configured to be separate separators; in the second direction, the first separator layer further comprises a third extension portion extending beyond the first outermost electrode plate and the first second-to-outermost electrode plate, and the third extension portion is disposed opposite to the first extension portion in the second direction; the second separator layer further comprises a fourth extension portion extending beyond the second outermost electrode plate and the second second-to-outermost electrode plate, and the fourth extension portion is disposed opposite to the second extension portion in the second direction; the third extension portion and the fourth extension portion are bonded together to form a second composite portion; and in the second direction, the second composite portion is located between the plurality of electrode plates and the second sidewall.

3. The secondary battery according to claim 1, wherein the first separator layer and the second separator layer are configured to be a one-piece separator, and the separator is a Z-shaped folded structure.

4. The secondary battery according to claim 1, wherein the pocket comprises a first packaging portion, a first cavity is provided in the first packaging portion, and the electrode assembly is at least partially accommodated in the first cavity; the first cavity comprises a first wall extending along the first direction; and a projection of the first composite portion projected onto the first wall in the second direction is located inside the first wall.

5. The secondary battery according to claim 1, wherein the first composite portion is a folded structure.

6. The secondary battery according to claim 2, wherein a length of the first composite portion or the second composite portion along the first direction is greater than or equal to 1 mm and less than or equal to a thickness of the electrode assembly along the first direction.

7. The secondary battery according to claim 1, wherein the first outermost electrode plate is a single-side-coated electrode plate, and the first second-to-outermost electrode plate is a double-side-coated electrode plate.

8. The secondary battery according to claim 7, wherein the pocket is an aluminum laminated film, the first outermost electrode plate is a positive electrode plate, the first second-to-outermost electrode plate is a negative electrode plate; and in the second direction, the first second-to-outermost electrode plate extends beyond the first outermost electrode plate.

9. The secondary battery according to claim 1, wherein the separator comprises a substrate layer, and the substrate layer comprises at least one of polyethylene or polypropylene.

10. The secondary battery according to claim 9, wherein the separator further comprises a first layer disposed on the substrate layer, the first layer comprises a first binder, and the first binder comprises at least one of polyvinylidene difluoride or polyacrylate ester.

11. The secondary battery according to claim 1, wherein the first extension portion and the second extension portion are hot-pressed to form the first composite portion.

12. The secondary battery according to claim 11, wherein the first composite portion comprises an indentation, and the indentation comprises a patterned protrusion structure.

13. The secondary battery according to claim 1, wherein the secondary battery further comprises a second binder, and the first extension portion and the second extension portion are bonded together by the second binder; and the second binder comprises at least one of polyacrylate ester, epoxy resin, rubber, hot-melt adhesive, or organosilicone.

14. The secondary battery according to claim 1, wherein no winding adhesive tape configured to bond and fix the first outermost electrode plate and the second outermost electrode plate is disposed in the secondary battery.

15. The secondary battery according to claim 1, wherein the pocket comprises a first packaging portion and a second packaging portion, the first packaging portion contains a cavity accommodating at least a part of the electrode assembly, the first packaging portion and the second packaging portion are connected together to form a sealing portion to accommodate a body portion of the electrode assembly and seal the body portion, the body portion comprises a first surface and a second surface extending along the second direction, the first surface and the second surface are disposed opposite to each other in the first direction, the first surface is located in the first packaging portion, the second surface is located in the second packaging portion, and a start end of the first composite portion is closer to the first surface than the second surface.

16. An electrical device comprising a secondary battery, wherein the secondary battery comprises:
an electrode assembly, comprising a plurality of electrode plates and a separator; in a first direction, the plurality of electrode plates are stacked, and the separator is disposed between two adjacent electrode plates among the plurality of electrode plates; the plurality of electrode plates comprise a first outermost electrode plate and a second outermost electrode plate located on two opposite sides in the first direction; the plurality of electrode plates further comprise a first second-to-outermost electrode plate adjacent to the first outermost electrode plate and of an opposite polarity than the first outermost electrode plate, and a second second-to-outermost electrode plate adjacent to the second outermost electrode plate and of an opposite polarity than the second outermost electrode plate; and the separator comprises a first separator layer located between the first outermost electrode plate and the first second-to-outermost electrode plate, and the separator further comprises a second separator layer located between the second outermost electrode plate and the second second-to-outermost electrode plate; and
a pocket, accommodating the electrode assembly, wherein the pocket comprises a first sidewall extending in the first direction; wherein
in a second direction perpendicular to the first direction, the first separator layer comprises a first extension portion extending beyond the first outermost electrode plate and the first second-to-outermost electrode plate, and the second separator layer comprises a second extension portion extending beyond the second outermost electrode plate and the second second-to-outermost electrode plate; the first extension portion and the second extension portion are bonded together to form a first composite portion; and in the second direction, the first composite portion is located between the plurality of electrode plates and the first sidewall.

17. The electrical device according to claim 16, wherein the pocket further comprises a second sidewall extending in the first direction, and the second sidewall and first sidewall are disposed opposite to each other in the second direction; the first separator layer and the second separator layer are configured to be separate separators; in the second direction, the first separator layer further comprises a third extension portion extending beyond the first outermost electrode plate and the first second-to-outermost electrode plate, and the third extension portion is disposed opposite to the first extension portion in the second direction; the second separator layer further comprises a fourth extension portion extending beyond the second outermost electrode plate and the second second-to-outermost electrode plate, and the fourth extension portion is disposed opposite to the second extension portion in the second direction; the third extension portion and the fourth extension portion are bonded together to form a second composite portion; and in the second direction, the second composite portion is located between the plurality of electrode plates and the second sidewall.

18. The electrical device according to claim 16, wherein the first separator layer and the second separator layer are configured to be a one-piece separator, and the separator is a Z-shaped folded structure.

19. The electrical device according to claim 16, wherein the pocket comprises a first packaging portion, a first cavity is provided in the first packaging portion, and the electrode assembly is at least partially accommodated in the first cavity; the first cavity comprises a first wall extending along the first direction; and a projection of the first composite portion projected onto the first wall in the second direction is located inside the first wall.

20. The electrical device according to claim 16, wherein the first composite portion is a folded structure.
